(19) United States
(12) Patent Application Publication
(10) Pub. No.: US 2007/0100121 A1
(43) Pub. Date: May 3, 2007

(54) INTEGRATED PROCESS FOR THE PREPARATION OF A POLYESTER RESIN

(76) Inventor: Evert Van Der Heide, Amsterdam (NL)

Correspondence Address: SHELL OIL COMPANY, P O BOX 2463, HOUSTON, TX, 772522463, US

(21) Appl. No.: 11/467,871

(22) Filed: Aug. 28, 2006

(30) Foreign Application Priority Data
Aug. 29, 2005 (EP) 05107895.4

(51) Int. Cl. C08G 63/02

(52) U.S. Cl. 528/272

(57) ABSTRACT

An integrated process for the preparation of a polyester resin, comprising the steps of (a) reacting an alkene with a suitable oxidant in the presence of an epoxidation catalyst to form an alkylene oxide, and (b) separating a crude alkylene oxide fraction comprising from 95% by weight to 99.95% by weight of alkylene oxide, and (c) reacting the crude alkylene oxide fraction with one or more compounds selected from the group consisting of dicarboxylic acids, dicarboxylic acid anhydrides and polyhydric alcohols to obtain a polyester resin.

### CROSS-REFERENCE TO RELATED APPLICATION

This application claims the benefit of European Patent Application No. 05107895.4, filed Aug. 29, 2005, which is incorporated herein by reference.

### FIELD OF THE INVENTION

The present invention provides an integrated process for the preparation of a polyester resin, a polyester resin obtainable by such process, and a formulation comprising such polyester resin.

Processes for the preparation of polyester resins are well known in the art. In this specification, the term “polyester resin” means the polymers formed by condensation of dicarboxylic acids such as phthalic acid and isophtalic acid, or dicarboxylic acid anhydrides such as maleic anhydride, phthalic anhydride with polyhydric alcohols such as 1,2-propylene diol, diethylene glycol and neopentyl glycol, leading to alternating copolymers, as defined in Kirk-Othmer, Encyclopedia of Chemical Technology, Vol. 18, p. 575 (1982).

GB 956,180 A relates to a process for the manufacture of esters and polyesters, wherein (i) olefinically or cyclo-olefinically unsaturated compounds containing at least 3 carbon atoms (propylene is mentioned as an example thereof) are epoxidised with saturated aliphatic monocarboxylic per-acids containing at least 5 carbon atoms, and (ii) the resulting mixture consisting of the epoxidised compound and the higher saturated aliphatic monocarboxylic acid containing at least 5 carbon atoms is converted into the ester by heating. An accelerator, such as zinc chloride, may be used in step (i). The monocarboxylic acid used in step (ii) is derived from the per-acid used in step (i). It is suggested in GB 956,180 A that before heating of the epoxides formed together with the monocarboxylic acids arising from the per-acids, polycarboxylic acids are added, such as unsaturated or saturated dicarboxylic acids, for manufacturing polyesters. In the Examples of GB 956,180 A such polyesters are not prepared.

In the process of GB 956,180 A, the epoxidised compound is not separated from the monocarboxylic acid derived from the per-acid (which is the oxidant used in step (i)), before carrying out (poly)ester production in step (ii). On the contrary, both said products from said step (i) are reactants in step (ii). Said two steps (i) and (ii) are carried out as a one-pot reaction.

Processes for the manufacture of polyester resins conventionally comprise contacting the raw materials at high temperatures under continuous removal of water.

A faster and more energy efficient process described in U.S. Pat. No. 5,880,251 employs alkylene oxide instead of an equivalent amount of mono-alkylene glycols. In this process, the alkylene oxide reacts with acid- and alcohol-functional compounds in an exothermic reaction and without release of water.

A disadvantage of the use of alkylene oxides resides in the cumbersome handling on an industrial scale, i.e. several thousand of tons per annum. In particular, storage, transport and handling of the environmentally hazardous and toxic alkylene oxides, such as ethylene oxide and propylene oxide are cumbersome and cost intensive.

A disadvantage of the use of alkylene oxides in the manufacture of polyester resins resides in the presence of poly(alkylene)oxide in the alkylene oxides. The presence of the poly(alkylene oxide) can be detrimental to the polyester production process due to gel formation, and frequently leads to undesired deviation in the properties of the desired polyester resin, such as molecular weight, molecular weight distribution, viscosity and functionality, and final application properties, for instance reduced applicability and reduced chemical stability of coatings. Due to the above reason, the use of alkylene oxide in polyester manufacture had been restricted to small-scale production and niche applications.

### SUMMARY OF THE INVENTION

Accordingly, the present invention provides for an integrated process for the preparation of a polyester resin, comprising the steps of
(a) reacting an alkene with a suitable oxidant in the presence of an epoxidation catalyst to form an alkylene oxide, and
(b) separating a crude alkylene oxide fraction comprising from 95% by weight to 99.95% by weight of alkylene oxide, and
(c) reacting the crude alkylene oxide fraction with one or more compounds selected from the group consisting of dicarboxylic acids, dicarboxylic acid anhydrides and polyhydric alcohols to obtain a polyester resin.

### DETAILED DESCRIPTION

Applicant found that the above-identified disadvantages could be overcome by employing an essentially crude alkylene oxide fraction, which has not been subjected to complex purification treatments. The subject process permits to manufacture polyester resins at an industrial scale on the basis of alkylene oxide, and with significantly reduced environmental risks and impact. “Integrated process” within the subject specification has the meaning that the processes for the manufacture of the alkylene oxide and of the polyester resin are combined into a single process. The integration with a process to produce alkylene oxide not only has the technical advantage of avoiding issues with poly(alkylene) oxide, but also results in a simpler process, and in significant cost reduction and reduced environmental risk due to the reduced handling, transport and intermediate storage. Furthermore, the capital and energy intensive purification of the alkylene oxide as otherwise required can be reduced or completely avoided. This may be conveniently achieved by placing the polyester manufacturing unit in the vicinity of the alkylene oxide manufacturing unit, which permits to directly transfer the crude alkylene oxide to the reactor. “Directly” within the subject specification has the meaning of a direct pipe connection, optionally with intermediate storage facilities, however not involving transport via road car tanker, or any other form of mobile tank.

In the present specification, the term “crude alkylene oxide fraction” refers to a crude alkylene oxide fraction comprising from 95.00% by weight to 99.95% by weight of alkylene oxide and of from 5.0% by weight to 0.05% by weight of compounds selected from the group consisting of water, aldehydes, ketones and acids, as obtainable by the subject process. The terms “wet” or “dry” crude alkylene oxides refer to alkylene oxide fractions as obtainable by process steps (a), (b1) and (b2), or (a) and (b1) to (b3), respectively, as set out herein-below.

Previously, only further purified alkylene oxide (further referred to herein as “pure alkylene oxide”) having an alkylene oxide content of more than 99.95% by weight was generally considered as satisfactory for the manufacture of alkylene oxide derivates. Pure alkylene oxide is generally prepared from crude alkylene oxide by complex and expensive purification treatments. This additional purification usually comprises multiple process steps, as the removal of impurities boiling close to the alkylene oxide, and/or forming azeotropic mixtures with the alkylene oxide is particularly difficult. Such purification requires complex equipment, and consumes large amounts of energy as well as involving the undesired handling of alkylene oxide, as outlined in EP-A-0755716, U.S. Pat. No. 3,578,568, and WO-A-02/070497. The above-described purification treatments also tend to generate poly(alkylene oxide) of high molecular weight in the purified alkylene oxide, which is known to lead to application problems, as described in U.S. Pat. No. 4,692,535 and WO-A-02/070497. Pure alkylene oxide is generally prepared from crude alkylene oxide by submitting crude alkylene oxide to one or more fractioned and/or extractive distillations of the crude alkylene oxide, whereby the alkylene oxide is separated as overhead product from contaminants having a higher boiling point for instance the extractive distillation under addition of heavier hydrocarbons, such as ethyl benzene or octane, whereby the alkylene oxide is separated as overhead product, as described in U.S. Pat. No. 3,881,996 and U.S. Pat. No. 6,024,840. Other suitable purification treatments include filtration and adsorption treatments with suitable adsorbents as described in U.S. Pat. No. 5,352,807. Pure alkylene oxide is considered to comprise on total composition more than 99.95% by weight of alkylene oxide. Preferably, pure alkylene oxide contains esters, aldehydes, and ketones in concentrations of less than 100 ppmw, preferably less than 50 ppmw, and most preferably less than 30 ppmw.

Suitable crude alkylene oxide for the subject process contains one or more of those alkylene oxides known to be useful in the preparation of polyester resins. Such alkylene oxides comprise advantageously aliphatic compounds comprising of from 2 to 8 carbon atoms, preferably comprising of from 2 to 6 carbon atoms, and most preferably comprising of from 2 to 4 carbon atoms.

Preferred alkylene oxides are selected from the group consisting of crude ethylene oxide, crude propylene oxide, and crude butylene oxide. More preferred crude alkylene oxides contain ethylene oxide and propylene oxide, of which crude propylene oxide is the most preferred.

Crude alkylene oxide as used in the subject process is prepared according to steps (a) and (b). In step (a), an alkene feed is reacted with a suitable oxidant. Suitable oxidants are capable of epoxidation of the alkene to the corresponding alkylene oxide. The oxidants include oxygen, and oxygen-containing gases or mixtures such as air and nitrous oxide. Other suitable oxidants are hydroperoxide compounds, such as aromatic or aliphatic hydroperoxides. The hydroperoxide compounds preferably include hydrogen peroxide, tertiary butyl hydroperoxide, ethyl benzene hydroperoxide, and isopropyl benzene hydroperoxide, of which ethyl benzene hydroperoxide is most preferred. Preferably, the oxidant is not a saturated aliphatic mono-carboxylic per-acid. More preferably, the oxidant is not a per-acid.

Suitable epoxidation catalysts may vary, depending on the substrate and oxidant. Suitable processes for the production of alkylene oxide include those described in U.S. Pat. No. 4,904,807, U.S. Pat. No. 5,519,152 and WO-A-2004/101141. For instance, the preparation of propylene oxide from propylene and an organic hydroperoxide oxidizing agent, such as ethyl benzene hydroperoxide or tertiary butyl hydroperoxide may be performed in the presence of a solubilized molybdenum catalyst, as for instance described in U.S. Pat. No. 3,351,635, or a heterogeneous titania on silica catalyst, as describe in U.S. Pat. No. 4,367,342 and U.S. Pat. No. 6,504,038. Olefin epoxidation using hydrogen peroxide and a titanium silicate zeolite is described in U.S. Pat. No. 4,833,260. Another commercially practiced technology is the direct epoxidation of ethylene to ethylene oxide by reaction with oxygen over a silver catalyst. Further, the direct epoxidation of olefins with oxygen and hydrogen in the presence of a catalyst, has for example been described in JP-A-4-352771, U.S. Pat. No. 5,859,265, U.S. Pat. No. 6,008,388, U.S. Pat. No. 6,281,369, JP-A-4-352771, U.S. Pat. No. 6,498,259, U.S. Pat. No. 6,441,204, and U.S. Pat. No. 6,307,073 which disclose the production of alkylene oxides using heterogeneous catalysts that incorporate a noble metal such as palladium or gold and a carrier such as titania or zeolites. A particularly preferred process for the preparation of propylene oxide is an integrated styrene monomer/propylene oxide process, as for instance described in U.S. Pat. No. 6,504,038. This process is particularly interesting if the polyester resin to be prepared is an unsaturated polyester resin. Preferably, in this process, at least part of the dicarboxylic acid or dicarboxylic acid anhydride comprises a compound capable of radically copolymerizing with the vinyl group of styrene monomer. Preferably, said compound is maleic acid and/or maleic acid anhydride.

The reaction mixture obtained in step (a) contains water and alkylene oxide as well as the oxidant, unreacted alkene and by-products of the reaction.

Alkylene oxide that is formed in step (a) is then separated in step (b) as a crude alkylene oxide fraction. This crude alkylene oxide fraction is generally known as “wet crude” alkylene oxide, and contains from 95% by weight to 99.95% by weight of alkylene oxide and of from 5% by weight to 0.05% by weight of compounds selected from the group consisting of water, aldehydes, ketones and acids. These impurities have boiling points close to the alkylene oxide, and/or form azeotropic mixtures with the alkylene oxide, which makes them difficult to remove.

Step (b) generally consists of (b1) removing unreacted alkene from the reaction mixture, and (b2) separating the wet crude alkylene oxide from the mixture obtained in step (b1) by at least one distillation treatment.

The wet crude alkylene oxide obtained in steps (b1) and (b2) contains minor quantities of by-products having a boiling point close to the alkylene oxides and/or forming azeotropic mixtures with the alkylene oxide such as aldehydes, as set out above, as well as water. It preferably contains from 50 to 5000 ppmw (parts per million by weight) of water, more preferably from 100 to 4800 ppmw of water. Yet more preferably, the wet crude alkylene oxide obtained from step (b) contains at most 4500 ppmw, again more preferably at most 4000 ppmw, yet more preferably at most 3500 ppmw, and most preferably at most 3000 ppmw of water.

In step (b1), a first distillation of the reaction mixture containing the alkylene oxide gives an overhead fraction containing unreacted alkene and some low boiling impurities. The distillation treatment can be carried out at a pressure of from 1 to 20×10⁵ N/m² (bar), and at a temperature range of from 10° C. to 250° C. The distillation can remove the unreacted alkenes along with other low boiling impurities can be removed from the crude alkylene oxide. Preferably, the crude alkylene oxide as used in the subject process is prepared in a process including the steps (a), (b1) and (b2), as this permits to reduce the size of the distillation unit of step (b2) while maintaining a high throughput. In step (b2), crude alkylene oxide is generally removed together with lower boiling contaminants as an overhead product from the reaction mixture obtained in step (b1). The distillation treatment can be carried out at a pressure of from 0.1 to 20×10⁵ N/m², and at a temperature range of from 0° C. to 250° C. Preferably, the distillation treatment is carried out at a pressure in the range of from 0.1 to 1×10⁵ N/m², and at a temperature in the range of from 10° C. to 200° C.

Wet crude alkylene oxide can be accommodated in the polyester resin production without or solely very small modification of the polyester formulation, since during the polyester formation these by-products become incorporated into the polyester resin. Without wishing to be bound to any particular theory, it is believed that in step (c), the water present in the wet crude alkylene oxide advantageously acts as a two-functional alcohol, or reacts with anhydrides present in the reaction mixture to form acids. Since the water is either reacting away into the polymer, or is removed continuously, no negative influence on the subject process was found.

Although wet crude alkylene oxide is the preferred raw material, for polyester formulations where the presence of water is undesired, “dry crude” alkylene oxide may be employed, which may be obtained by adding an optional step (b3). In this step (b3), part of the water still present in the alkylene oxide fraction obtained in step (b2) may be removed as an overhead product from the crude alkylene oxide, as for instance described in U.S. Pat. No. 3,607,669. In such distillation treatment, one or more entrailer components may be added to the crude alkylene oxide. Entrailer components are compounds that are added to the material to be separated, and which facilitate a distillation, for instance by changing of the equilibrium of an azeotrope, and hence simplify the separation and thus the process. Preferred entrailer components are aliphatic hydrocarbons having 4 or 5 carbon atoms. The distillation treatment can be carried out at a pressure of from 1 to 20×10⁵ N/m², and at a temperature range of from 0° C. to 200° C. Preferably, the distillation treatment is carried out at a pressure in the range of from 5 to 10×10⁵ N/m², and at a temperature in the range of from 10° C. to 150° C. The dry crude alkylene oxide obtained in step (b3) preferably contains from 0.01 to 150 ppmw of water, more preferably from 10 to 150 ppmw of water. Yet more preferably the dry crude alkylene oxide obtained from step (b3) contains less than 120 ppmw of water, again more preferably less than 100 ppmw of water, even more preferably less than 80 ppmw, and most preferably less than 50 ppmw of water.

The crude alkylene oxide fraction comprises on total composition from 95% by weight to 99.95% by weight of an alkylene oxide selected from the group consisting of ethylene oxide, propylene oxide or butylene oxide, and of from 5.0% by weight to 0.05% by weight of compounds other than alkylene oxide. Preferably, the crude alkylene oxide fraction comprises at least 96% by weight of alkylene oxide, more preferably more than 96% by weight, even more preferably at least 97% by weight, more preferably more than 97% by weight, even more preferably at least 99% by weight, again more preferably more than 99% by weight, and most preferably at least 99.5% by weight of alkylene oxide. Preferably, the crude alkylene oxide fraction comprises at most 99.93% by weight of alkylene oxide, more preferably less than 99.90% by weight, again more preferably at most 99.85% by weight, yet more preferably less than 99.83% by weight, again more preferably at most 99.8% by weight, more preferably less than 99.8% by weight, yet more preferably at most 99.79% by weight, and most preferably at most 99.78% by weight of alkylene oxide, the remainder being compounds originating from the epoxidation reaction of step (a), or reaction products of these compounds during steps (a) and/or (b).

The crude alkylene oxide fraction may contain hydrocarbons such as alkenes and alkanes, and oxygen containing by-products such as aldehydes, ketones, alcohols, ethers, acids and esters, such as water, acetone, acetic aldehyde, propionic aldehyde, methyl formate, and the corresponding carbon acids.

The crude alkylene oxide fraction may also comprise a small quantity of poly(alkylene oxide) having a weight average molecular weight of more than 2000, however preferably less than 50 ppmw. Unless stated otherwise, the molecular weights mentioned are weight average molecular weights, and the functionality is the nominal functionality (Fn).

The crude alkylene oxide fraction more preferably contains at most 30 ppmw of poly(alkylene oxide) having a weight average molecular weight of more than 2000, yet more preferably at most 20 ppmw particularly more preferably at most 15 ppmw, again more preferably at most 12 ppmw, yet more preferably at most 5 ppmw, and most preferably contains at most 3 ppmw of poly(alkylene oxide) having a weight average molecular weight of more than 2000. Whereas the separation of most of the water, and lighter boiling impurities such as unreacted alkene can be effected without difficulty by steps (b1) and (b2), the separation of hydrocarbons, aldehydes and acids from the alkylene oxide is particularly difficult, even by fractional distillation. Separation of these close-boiling contaminants requires for instance columns with a very high tray-number, and hence strongly limited throughput. Preferably, the dry crude alkylene oxide contains at least 5, ppmw of water, more preferably 10 ppmw of water, since a further reduction of the water content would be costly and cumbersome.

Accordingly, the subject process preferably also relates to the co-polymerization of an alkylene oxide, a polyhydric alcohol and/or a dicarboxylic acid and/or dicarboxylic acid anhydride, an aldehyde and/or ketone. Under the conditions for polyester manufacture, the aldehyde or ketone will react into the polyester resin with any nucleophilic group, such as alcohols under formation of an acetal or ketal structure. The present invention also pertains to the polyester resins obtainable by the subject process. These polyester resins preferably contain from 0.02 to 5% by weight of units derived from an aldehyde, alcohol, acid or ketone as obtained as by-products of steps (a) and (b).

The crude alkylene oxide fraction separated in step (b) comprises of from 5.0% by weight to 0.05% by weight of compounds other than alkylene oxide (impurities). Because of these impurities, the final polyester resin prepared from such crude alkylene oxide is different from one having been prepared from pure alkylene oxide. Therefore, the polyester resin obtainable by the present process is different from prior art polyester resins which have been made from pure starting materials.

The crude alkylene oxide may be employed according to the subject invention as sole alkylene oxide, or in combination with at least one pure alkylene oxide. This may be advantageous, if for instance at the polyol production site only one crude alkylene oxide is produced, whereas other alkylene oxides not produced at the site are required in the polyol formulation. Hence, these additional alkylene oxides may be sourced as commercially available pure alkylene oxides. Pure alkylene oxide may be introduced into the polyester formulation prior to or during the process, for instance by first feeding a crude alkylene oxide, and in a later stage of the process by feeding a mixture of a crude and pure alkylene oxide, or by mixing crude alkylene oxide and pure alkylene oxide in situ throughout the process, or by mixing the alkylene oxides before the addition to the other components of the reaction. Advantageously, in a formulation where more than one alkylene oxide is required, for instance for polyester resins containing propylene oxide and ethylene oxide moieties, a combination containing from 50 to 99% by weight of at least one crude alkylene oxide, and from 50 to 1% by weight of at least one pure alkylene oxide is employed.

Preferably, the combination contains at least 75% by weight of crude alkylene oxide, more preferably at least 80% by weight and most preferably 85% by weight of crude alkylene oxide. The subject process is preferably carried out in such way, that the mixture of crude and pure alkylene oxide comprises on total composition from 95% by weight to 99.95% by weight of one or more alkylene oxides selected from the group consisting of ethylene oxide, propylene oxide and butylene oxide, and of from 5% by weight to 0.05% by weight of compounds other than alkylene oxide stemming from the production of the crude alkylene oxide.

In step (c), the crude alkylene oxide fraction obtained in step (b) is reacted with other raw materials to form the unsaturated polyester resin. This involves an initial reaction between a carboxylic acid functional compound and the alkylene oxide, optionally in the presence of a catalyst to form a hydroxyalkyl ester reaction product, which then can react further with alkylene oxide and/or andydride present. Preferably, the crude alkylene oxide and one or more dicarboxylic acid anhydrides are reacted under the initiation by an initiator compound having one or more active hydrogen atoms. Initiator compounds according to the subject process are compounds having at least 1, preferably from 2 to 6 active hydrogen atoms. The active hydrogen atoms are typically present in the form of hydroxyl groups, but may also be present in the form of e.g. amine groups, thiol groups or carboxylic groups. Suitable initiator compounds include water, alcohols containing at least one active hydrogen atom per molecule available for reaction with either the anhydride, or the propylene oxide. Suitable aliphatic initiator compounds include polyhydric alcohols containing of from 2 to 6 hydroxyl groups per molecule. Examples of such initiator compounds are diethylene glycol, dipropylene glycol, glycerol, di- and polyglycerols, pentaerythritol, trimethylolpropane, triethanolamine, sorbitol, mannitol, 2,2′-bis(4-hydroxylphenyl)propane (bisphenol A), 2,2′-bis(4-hydroxylphenyl)butane (bisphenol B) and 2,2′-bis(4-hydroxylphenyl)methane (bisphenol F). Preferred are aliphatic alcohols containing at least 1, more preferably at least 2 active hydrogen groups in the form of hydroxyl groups. Preferably, the aliphatic alcohols contain at most 5, more preferably at most 4, and most preferably at most 3 hydroxyl groups per molecule.

The ring-opening reaction between initiator compound and the anhydride, or the alkylene oxide leads to a polymerization of alternating units of the alkylene oxide mono-glycol and dicarboxylic acid, bonded by ester linkages, although ether linkages are possible, and can be tolerated in the final polyester resin. Preferably, the dicarboxylic acid anhydride used in step (c) of the present process is a cyclic anhydride.

The reaction of step (c) preferably is effected in the presence of a suitable catalyst. Suitable catalysts comprise compounds comprising a divalent metal selected from the group consisting of zinc, tin, manganese, magnesium and/or calcium, such as the equivalent oxides, chlorides, acetates, butyrates, phosphates, nitrates, stearates, octanoates, oleates and naphthenates, or amines, as described in U.S. Pat. No. 4,306,056, and alkyl quaternary amine compounds U.S. Pat. No. 4,560,788. Compounds of zinc, such as zinc chloride, zinc acetate or zinc oxide are particularly desirable inasmuch as light colored products are obtained by their use. Other suitable catalysts include ion exchange resins such as Amberlite IR-45 (OH) (amine type resin) Amberlite IRC-50 (carboxylic acid type resin), and salts of lead, cobalt, rare earth, cadmium and nickel. The catalyst may be employed in various amounts, for example, in a range of 0.001 to 1% by weight, based upon the dicarboxylic acid anhydride and the initiator compound. The reaction is generally carried out at a temperature in the range of from 100° C. to 240° C., and at a pressure in the range of from 1 to 15 bar. This preferred embodiment of the present process permits to produce unsaturated polyester resins having the desired properties for various applications. Different functionality of the initiator molecules, as well as temperatures and weight ratio of the crude alkylene oxide to the dicarboxylic acid anhydride allows producing polyester resins with different molecular weights, and molecular weight distribution and functionality. Such resins may be for instance formulated on the basis of a crude propylene oxide fraction, phthalic acid anhydride and maleic acid anhydride.

Alternatively, the reaction in step (c) may be effected in several different steps, optionally also involving a condensation reaction. Preferably, the crude alkylene oxide fraction is first reacted with a dicarboxylic acid to obtain an ester oligomer. After completion of this first stage, polyhydric alcohol and diacid or diacid anhydride are added, and the reaction mixture is allowed to react further at a temperature in the range of from 100° C. to 240° C., eventually yielding the desired unsaturated polyester product. This allows to introduce different functionalities, and to design a specific resin structure of different blocks.

However, all of the raw materials may be present in the reactor, and the reaction of step (c) may also be conducted as a single stage reaction. Step (c) may be performed in a single reactor, or if conducted in separate stages, the oligomer may be separated first, and then reacted. Preferably, however, the reaction is performed in a single reactor, and in presence of all or most of the raw materials used. Suitable dicarboxylic acids or dicarboxylic acid anhydrides include for instance phthalic acid, phthalic anhydride, isophthalic acid, terephthalic acid, hexahydrophthalic anhydride, tetrahydro phthalic anhydride, adipic acid, sebacic acid, and/or azelaic acid, which may be used alone or in combination with α,β-unsaturated dicarboxylic acids, such as fumaric acid, maleic acid, itaconic acid, citraconic acid, mesaconic acid, chloromaleic acid, and anhydrides thereof. Preferred are phthalic acid or phthalic anhydride, isophthalic acid, fumaric acid, maleic acid and maleic anhydride. The first stage addition reaction is generally carried out at a temperature in the range of from 100° C. to 240° C., and at a pressure in the range of from 0.1 to 1.5 MPa (1 to 15 bar). Suitable polyhydric alcohols include diols such as ethylene glycol, diethylene glycol, propylene glycol, dipropylene glycol, trimethylene glycol, 1,3-butane diol, 1,4-butane diol, 2-methyl-1,3-propane diol, 1,6-hexane diol, cyclohexane diol, neopentyl glycol, 2,2,4-trimethyl-1,3-pentane diol, 1,4-cyclohexane dimethanol; glycols such as hydrogenated bisphenol A, alkylene oxide adducts of hydrogenated bisphenol A, alkylene oxide adducts of bisphenol A; triols such as glycerol; trimethylol propane; or tetraols such as pentaerythritol, all of which may be used alone or in combination.

In step (c) of the present process, the crude alkylene oxide fraction is reacted with one or more compounds selected from the group consisting of dicarboxylic acids, dicarboxylic acid anhydrides and polyhydric alcohols. Preferably, said one or more compounds are selected from the group consisting of dicarboxylic acid anhydrides and polyhydric alcohols. More preferably, said one or more compounds are dicarboxylic acid anhydrides.

Preferably at least part of the dicarboxylic acid and/or dicarboxylic acid anhydride comprises an unsaturation capable of copolymerization with the styrene monomer. Such unsaturation includes in particular ethylenically unsaturated compounds, such as fumaric acid and maleic acid. The unsaturation is required in order to allow the polyester resin to copolymerize with styrene monomer, which is employed as both solvent as well as co-monomer for the polyester resin. Further raw materials commonly used as co-monomers for the unsaturated polyester resin include vinyl esters and alcohols, and other acetylenically and olefinically unsaturated compounds, provided that at least a small degree of copolymerization with styrene monomer is possible. Preferably, the unsaturated polyester resin according to the present invention includes, but is not specifically limited to, the reaction products of an α,β-unsaturated carboxylic acids with a polyhydric alcohol. Preferred examples of the α,β-unsaturated dicarboxylic acid include fumaric acid, maleic acid, itaconic acid, citraconic acid, mesaconic acid, chloromaleic acid, and anhydrides thereof. These α,β-unsaturated carboxylic compounds may be used alone or in combination. The unsaturated polyester resins according to the subject invention are formulated in such way, that they can copolymerize with styrene monomer in their final application. This copolymerization is usually effected by the addition of radical starter, i.e. a compound that will create radicals upon exposure to heat, such as organic peroxides, inorganic, as for instance alkali metal salts of peracids and azo-compounds. Copolymerization is as defined in Young, Polymer Handbook, Chapter II, J. Brandrub, E. H. Immergut and W. McDowell,Eds., Wiley-Interscience, New York, 1975.

Again more preferably, in step (c) of the subject process, the unsaturated compound comprises maleic acid, and/or more preferably, maleic acid anhydride. The double bond of the maleic acid or anhydride has a cis-configuration, leading to polyester chains that have a high degree of steric hindrance. This usually decreases the rate of the final crosslinking reaction with styrene monomer. However, if during the polyester condensation reaction the temperature is brought into the range of from 180 to 200° C., the cis-configured double bond is transformed to the trans-isomer, i.e. a fumaric acid structure. Polyester resins containing fumaric acid units in the polyester resin chain have a 20 times higher reactivity towards styrene than those containing solely maleic acid units. Without wishing to be bound to any particular theory, this is attributed to the reduced steric hindrance due to the more linear configuration.

Accordingly, the present process is preferably conducted in such way, that steps (c) are performed in such way, that at least part of any maleic acid unit present are converted to the fumaric acid configuration, more preferably that essentially all of the all maleic acid units are converted to the fumaric acid configuration.

The subject invention also relates to a process for the manufacture of an unsaturated polyester resin. “Unsaturated polyester resin” means the polymers formed by condensation of unsaturated dicarboxylic acids such as maleic acid or the respective dicarboxylic acid anhydride with a polyhydric alcohols and the alkylene oxide. The obtained polyester resin is then blended with styrene monomer, and optionally with other resin types such as thermoplastic resins, epoxy resins or polyurethanes as required by the final application, as described Koon-Ling Ring et al., “Unsaturated Polyester Resins”, Chemical Economics Handbook, 580.1200, April 1999 and “Polyesters, Unsaturated”, Encyclopedia of Polymer Science and Engineering; 3d ed., Vol. 12. p. 256.

In the case of unsaturated polyester resins, the alkylene oxide preferably is propylene oxide stemming from an integrated propylene oxide/styrene monomer process. This allows the use of minimally stabilized styrene monomer, and adds to the cost efficiency and reduced environmental risk by directly linking the two processes together. Accordingly, the subject process is therefore preferably directly linked to the styrene monomer/alkylene oxide process.

Styrene monomer is usually stabilized against uncontrolled polymerization by the addition of small amounts of a radical inhibitor, usually a phenolic compounds such as for instance hydroquinone, trimethyl hydroquinone, p-tertiary butyl catechol, tertiary butyl hydroquinone, toluyl hydroquinone, p-benzoquinone, naphthoquinone, hydroquinone monomethyl ether, phenothiazine, copper naphthenate, copper chloride and the like. In particular the quinone type radical inhibitors need the presence of dissolved oxygen in about stoichiometric quantities in order to remain active, an are employed in the range of from 10 to 50 parts per million. An unsaturated polyester resin blended with stabilized styrene monomer requires an increased amount of the radical initiator in application in order to neutralize the effect of the stabilization, resulting in increased costs and higher concentration of highly dangerous compounds. The presence of stabilizers in styrene monomer reduces the reactivity. Therefore, the styrene monomer obtained in step (b) is preferably directly transferred to the reactor of step (c), and more preferably not stabilized, or only stabilized to the level required for intermediate storage and transfer to the polyester reactor. Styrene monomer is preferably added to the unsaturated polyester resin in amount, so that a weight ratio of polyester resin to styrene monomer from 40:60 to 99:1 weight/weight, preferably, in the range of from 55:45 to 97:3 is achieved. The determination of the required amounts of styrene monomer and polyester resin is within the normal skills of a person skilled in the art.

A further raw material of considerable importance for unsaturated polyester resins is dicyclopentadiene (DCPD). This compound is usually added during the process for the preparation of unsaturated polyester resins. Above a temperature of 140° C., the DCPD dissociates into two cyclopentadiene molecules. These then undergo a Diels-Alder reaction with cis-configured maleic anhydride, thereby introducing a rigid bicyclic structure into the polyester resin structure. This increases rigidity and hence the glass transition temperature of the polyester, while also increasing the hydrophobicity of the material.

As a result, drying times in hand lay up applications are reduced, as well as the required amounts of styrene. Further, due to the high hydrophobicity of such resins, these unsaturated polyester resins are widely used in marine and sanitary applications. Accordingly, step (d) is preferably performed at a temperature of at least 140° C. and in the presence of dicyclopentadiene. A disadvantage of the use of dicyclopentadiene is the strong typical smell of this product. Even in minimal amounts, DCPD will impart its typical smell to all tubing, piping and tanks that it is brought into contact with. It is generally considered difficult and cost intensive to clean the equipment sufficiently to remove this smell, and hence dedicated transport and handling material is usually required. Accordingly, the present process is preferably performed in such a way that it is performed at a location where DCPD is manufactured. The DCPD can then directly be used in the subject process without intermediate handling and storage and/or transport, rendering the amount of dedicated equipment minimal.

The unsaturated polyester resins are formulated in such a way that they can copolymerize with styrene monomer in their final application. This copolymerization is usually effected by the addition of radical starter, i.e. a compound that will create radicals upon exposure to heat, ultraviolet light, electron beams or similar sources of initiation energy. The amount of the radical starter is preferably within a range of 0.1-10 parts by weight, and particularly within a range of 1-5 parts by weight based on 100 parts by weight of the unsaturated polyester resin composition. Heat-activated radical starters include organic peroxides, such as for instance diacyl peroxides, peroxy esters, hydroperoxides, ketone peroxide, alkyl peresters and percarbonate compounds, and alkali metal salts of peracids. Ultraviolet light-activated radical starters are photosensitive compounds, for instance acylphosphine oxide, benzoyl ether, benzophenone, acetophenone, thioxantone compounds.

Electron radiation-activated radical starters include halogenated alkylbenzene, disulfide compounds and similar compounds. Further additives that can accelerate or mediate the radical reaction, and which may be used in combination with the above described curing agent include metal salts such as cobalt naphthenate and cobalt octonate, tertiary aromatic amines such as N,N-dimethylaniline, N,N-di(hydroxyethyl) p-toluidine and dimethylacetoacetamide.

Depending on the desired application, to the polyester resin formulation optionally other resins and additives may be added. These include thermoplastic resins, epoxy resins or polyurethanes. Therefore, the present invention also relates to a formulation comprising a polyester resin obtainable by the process according to the present invention, said formulation further comprising a thermoplastic resin, an epoxy resin, and/or a polyurethane resin.

1. An integrated process for the preparation of a polyester resin, comprising the steps of
(a) reacting an alkylene with a suitable oxidant in the presence of an epoxidation catalyst to form an alkylene oxide, and
(b) separating a crude alkylene oxide fraction comprising from 95% by weight to 99.95% by weight of alkylene oxide, and
(c) reacting the crude alkylene oxide fraction with one or more compounds selected from the group consisting of dicarboxylic acids, dicarboxylic acid anhydrides and polyhydric alcohols to obtain a polyester resin.

2. A process according to claim 1, comprising a further step of removing water from the crude alkylene oxide fraction by at least one distillation treatment prior to step (c).

3. A process according to claim 1, wherein the crude alkylene oxide fraction comprises on total composition from 95% by weight to 99.95% by weight of one or more alkylene oxides selected from the group consisting of ethylene oxide, propylene oxide and butylene oxide.

4. A process according to claim 1, wherein the crude alkylene oxide fraction comprises from 50 to 5000 ppmw of water, based on total composition.

5. A process according to claim 1, wherein the alkylene oxide is propylene oxide as obtained in a process for the joint preparation of styrene monomer and propylene oxide.

6. A process according to claim 5, wherein at least part of the dicarboxylic acid or dicarboxylic acid anhydride comprises a compound capable of radically copolymerizing with the vinyl group of styrene monomer.

7. A process according to claim 6, wherein the dicarboxylic acid or dicarboxylic acid anhydride comprises maleic acid and/or maleic acid anhydride.

8. A process according to claim 1, wherein step (c) is conducted by reacting the crude alkylene oxide fraction with one or more dicarboxylic acid anhydrides under initiation by a compound having one or more active hydrogen atoms.

9. A process according to claim 5, wherein step (c) is performed at a temperature of at least 140° C. in the presence of dicyclopentadiene.

10. A process according to claim 7, wherein the styrene monomer is added to the polyester resin to obtain an unsaturated polyester resin formulation having a weight ratio of polyester resin to styrene monomer from 40:60 to 99:1 weight/weight.

11. A polyester resin obtainable by the process according to claim 1.

12. A formulation comprising a polyester resin obtainable by the process according to claim 1, further comprising a thermoplastic resin, an epoxy resin, and/or a polyurethane resin.
